(19) United States
(12) Patent Application Publication
(10) Pub. No.: US 2011/0133682 A1
(43) Pub. Date: Jun. 9, 2011

(54) METHOD AND DEVICE FOR DETECTING STEP LOSSES OF A STEP MOTOR

(76) Inventors: Heinz Egger, Grambach (AT); Bernhard Heinz, Proleb (AT); Jurgen Schuhmacher, Linsengericht (DE)

(21) Appl. No.: 12/745,606

(22) PCT Filed: Dec. 3, 2008
(86) PCT No.: PCT/EP08/10212

§ 371 Date: Feb. 23, 2011

(30) Foreign Application Priority Data
Dec. 3, 2007 (EP) 07023353.1

(51) Int. Cl. G05B 19/40

(52) U.S. Cl. 318/685

(57) ABSTRACT

For activating a stepper motor, a pulse-width modulated current is supplied to a coil of the stepper motor and it is determined whether the current flowing through the stepper motor, based on a default value, lies within a current bandwidth defined by an upper switching threshold and a lower switching threshold. The current supply to the coil is switched on when the detected current has dropped to the lower threshold and is switched off when the detected current has risen to the upper threshold. In order to detect a step loss, the signal form of the current or its change, respectively, is analyzed and deviations from desired values or desired value ranges, respectively, which have been caused by step losses, are detected. The determination of the signal form of the current or its change, respectively, may occur indirectly by analyzing a corresponding control signal.

### CROSS-REFERENCE TO RELATED APPLICATIONS

This patent application is a U.S. national counterpart of international application serial no. PCT/EP2008/010212 filed on Dec. 3, 2008, which claims priority to European Patent Application No. 07023353.1 filed on Dec. 3, 2007, each of which is hereby incorporated herein by reference.

### BACKGROUND OF THE INVENTION

The stepper motor is a special design of synchronous machines and is composed of a fixed stator designed with several coils and a rotor rotating therein. Depending on the mode of construction of the rotor, three basic types of stepper motors are differentiated:
the stepper motor excited by means of a permanent magnet,
the stepper motor with variable reluctance and
the hybrid stepper motor.

In the stepper motor excited by means of a permanent magnet, the rotor consists of a cylindrical permanent magnet with radial magnetization. This means that permanent magnets of different polarities alternate with each other along the rotor circumference. The rotor always aligns itself with the magnetic field generated by the energization of the coils. If the coils are switched on one after the other, the rotor turns into the corresponding direction. Accordingly, the stepper motor performs a revolution if all coils are switched on and off one after the other.

In the stepper motor with variable reluctance, the rotor consists of a de-energized toothed soft-iron core. With this design, the moment arises due to the rotor construction which provides a variable magnetic air-gap resistance. The rotor follows the stepper field, since it seeks to align itself in the stator field such that the magnetic energy in the air gap becomes minimal.

The hybrid stepper motor is a hybrid between a stepper motor excited by means of a permanent magnet and a variable reluctance stepper motor. It consists of an axially polarized permanent magnet at the ends of which toothed rotor discs made of a soft-magnetic material are attached. The two rotor discs are biased by the permanent magnet and are offset relative to each other by half a tooth width so that the north and south poles will alternate. Very small stepping angles are possible with the hybrid stepper motor, and it has a self-retaining moment. However, this is a complicated design.

Stepper motors function according to the synchronous principle. The torque driving the rotor results from differently aligned magnetic fields in the stator and the rotor. The rotor always rotates such that the largest possible magnetic flux will form.

In contrast to other motors, the stepper motor has coils only located in the stator. Hence, the rotating motion is produced by selectively activating the individual coil windings, which causes the stator field to be relayed by a particular angle after each step pulse. Relaying the stepper field is also referred to as a commutation process.

In this way, the sense of rotation and the rotational speed of the motor can be controlled most easily. In order to determine the position of the rotor, it suffices to count the steps in a clockwise and in an anticlockwise direction, respectively, starting from an initial position, and to multiply them by the stepping angle.

As regards the activation of the motor winding, a unipolar and a bipolar activation can be distinguished.

With a unipolar activation, each pole has two windings or one winding with a centre tapping, respectively. The direction of the magnetic field depends on which one of the two windings is energized. The advantage of this activation is the small electronic expenditure. The disadvantage is a poor utilization of the winding space of 50%, since always only one winding is used, depending on the current direction. Besides, the use of two coils per pole results in a larger motor.

With a bipolar activation, each pole has only one winding. The direction of the magnetic field depends on the direction in which the current flows through said one winding. This type of activation has the advantage that the entire winding space is utilized. A disadvantage is the higher electronic expenditure.

Stepper motors can be operated in several ways. The most simple mode of operation is the WaveDrive in which always only one coil is energized progressively around the circumference. The advantage of this mode of operation is that it is easy to implement and can be realized easily also with very inexpensive microcontrollers. A disadvantage, however, is the lower torque, since as always only one coil is energized, it decreases by a factor of 1/√2, i.e., to about 70% of the theoretical maximum.

In contrast, in the full-step mode, all winding systems are always energized. The rotating motion is achieved by selectively changing the current direction in the windings. As a result of the fact that all winding systems are always energized, the highest possible torque is obtained in this mode of operation. The relatively large steps are disadvantageous, whereby the motor tends to perform resonance vibrations.

In the half-step mode, the WaveDrive and the full-step mode are combined with each other. In a stepper motor comprising two coils, one or both coils is/are thus always energized alternately. Thereby, more angular positions can be approached. The result is indeed a higher circuit complexity, but also a higher positioning accuracy. However, the motor always “jumps” back to one of the full-step positions, as soon as the current is switched off. The major advantage of the half-step mode is that the motor vibrates significantly less, since the rotor is exposed to a smaller number of impulses. In comparison, in the full-step mode and in the WaveDrive, the rotor is always pulled from one position into the next one and vibrates there around the final position. These vibrations also produce vibrations of the casing and the form of torque is jerky. The total system is thus relatively noisy. Due to the larger number of positions in the half-step mode, the stepping angles are smaller and, hence, the vibrations decrease. It is generally true that, the smaller the steps become, the more uniform is the force path and the more silent is also the total system. Moreover, a step loss will be less probable, since the rotor vibrations decrease.

If the concept of reducing the stepping angles by increasing the partial steps is developed further and further, the conclusion can be drawn that a sinusoidal or cosinusoidal activation, respectively, is the optimum. In this case, the force path would be uniform, and only the fundamental component of the frequency at which the motor is activated would be audible. The microstep operation implements precisely that. In practice, however, the activation is not effected with a precisely sinusoidal signal, but pulse-width modulated square wave currents having a switching frequency above the threshold of audibility are utilized. In doing so, the motor coil itself serves as a filter and smoothes the square wave signal to such an extent that a roughly sinusoidal or cosinusoidal current, respectively, will flow through the windings.

As already mentioned, stepper motors are used mainly for positioning tasks. The advantage of these motors is that the position of the motor can be determined easily by taking into account the steps which correspond to a predetermined quantized motion. Nevertheless, stepper motors are used only rarely without a positioning sensor system. The reason for this is the possible occurrence of step losses.

Step losses occur if the rotor can no longer follow the rotating magnetic field of the stator—the motor stalls. The cause of this is, in most cases, a load which is too high or a mechanical blockade.

For detecting these undesirable step losses and, subsequently, correcting the positioning error resulting therefrom, there are basically two possibilities:
with the aid of sensors (e.g., measuring the rotational speed)
without additional sensors across the electromagnetic field of the motor.

The use of sensors for the detection of step losses is well-tried, but expensive, for which reason possibilities of avoiding them are being searched for.

In the sensorless step loss detection, the motor itself serves as a sensor. This is made possible by particular characteristics of a stepper motor which involve that the electromagnetic field of the motor will change due to the load put on the motor. In particular, the stepper motor has the characteristic that the rotational speed will remain constant under load, but a phase shift between the rotor and the rotary field will occur. Analogously to the synchronous machine, this phase shift angle is referred to as a rotor displacement angle. The lagging of the rotor relative to the stator under a load is explained in FIG. 1. In the left-hand image of FIG. 1, the rotor runs at idle, the rotor displacement angle is zero. If more load is now put on the rotor, it starts to lag after the stator field Φ, which is shown in the right-hand image. Starting from a particular motor-dependent load, the rotor displacement angle will become too large and the magnetic field of the following stator coil will be closer to the rotor than the magnetic field which it currently follows. The rotor will then end up in the following magnetic field. This is referred to as a step loss. If the load becomes too large, the rotor will be unable to follow any magnetic field, but will only vibrate. In this case, the motor continuously loses steps. Precisely this phenomenon also occurs if the motor is started at a frequency which is too high. Due to the rotor's moment of inertia, it is unable to immediately follow a quickly rotating magnetic field. Thus, in order to be able to operate the motor at higher frequencies, the motor has to be started more slowly and then has to be accelerated by means of a frequency ramp. The frequency at which the motor can just barely be started is, at the same time, also the one at which the motor comes to a stop within one step, if the current is switched off. It is referred to as the start/stop frequency.

As can be seen in the electrical equivalent circuit diagram of the stepper motor according to FIG. 2, the motor winding consists of an inductive component (L_{W}) and an ohmic resistance component (R_{W}). The generator voltage U_{M} generated in the stepper motor is proportional to the rotational speed. The described lagging of the rotor relative to the magnetic field of the stator under a load results in an enlargement of the air gap between the stator and the rotor through which the magnetic flux Φ passes, this air-gap enlargement in turn leads to a reduction in the inductance L_{W}.

The firm Trinamic Microchips has brought a driver for stepper motors to the market under the name of TMC246/249, which driver is able to detect a step loss via the generator voltage of the stepper motor. However, said driver is usable only to a limited extent, since the principle of measurement fails in case of small motors and rotational speeds because the generator voltage is too small for being able to make reliable statements about the state of the load.

The inductance must be measured for an ascertainment of step losses based on the load-dependent motor inductance. Two methods are available for measuring the motor inductance:
via the amplitude of the winding current, and
via the phase shift between voltage and winding current.

In Helmut Oswald, “FPGA Schrittmotorsteuerung mit Lastmessung/Schrittverlusterkennung über das elektromagnetische Feld des Motors”, Thesis at the Fachhochschule Technikum Wien, 2006, the possibilities of an inductance measurement have been examined and, based on these findings, a stepper motor control has been established. The measuring method proposed in this document is based on the fact that the phase displacement between current and voltage is measured and the inductance is inferred therefrom. The problem of this measuring method is, however, that the effects of the variations in inductance become very small below a particular frequency. Therefore, also this measuring method is usable only to a limited extent.

Hence, there is still a requirement for an activation of stepper motors which, at the same time, enables the detection of step losses. In particular, such an activation and step loss detection device should have a small installation space, enable the detection of step losses without external sensors and thus in a cost-efficient manner, offer high detection precision across a large load and rotational speed range (also with small overall sizes) as well as ensure an operation of the stepper motor which is as smooth and vibration-free as possible.

### SUMMARY OF THE INVENTION

It is against the above background that the present invention provides certain unobvious advantages and advancements over the prior art. In particular, the inventor has recognized a need for improvements in a process and device for detecting step losses of as stepper motor.

Although the present invention is not limited to specific advantages or functionality, it is noted that the present invention can provide a stepper motor that is activated here by supplying a pulse-width modulated voltage (PWM) to a coil of the stepper motor while detecting the current flowing through the coil. By way of comparison, it is determined whether the detected current, based on a default value, lies within a current bandwidth defined by an upper switching threshold and a lower switching threshold, wherein the current supply to the coil is switched on when the detected current has dropped to the lower threshold and the current supply to the coil is switched off when the detected current has risen to the upper threshold. By means of the invention, a “current band guide” is thus realized in which the current through the coil can deviate from a default value, which preferably is roughly sinusoidal, only within a certain “current bandwidth”.

For a precise and easily adjustable control of the progression of the default value, the use of a digital-to-analog converter is suggested which has the values allocated to it on its digital input by a controller, e.g., an FPGA.

Due to the improved processability of the signals, it is envisaged that the detected current is converted into a proportional voltage signal for further processing, which voltage signal is optionally cleared from high-frequency interferences in a low-pass filter.

In a preferred embodiment of the invention, the detected current or the voltage signal proportional to the detected current, respectively, is subtracted from the default value and optionally amplified prior to a comparison with the upper switching threshold and the lower switching threshold. The implementation of this function is effected, for example, using a differential amplifier.

The resulting differential signal has a signal form which, reduced by the default value, is proportional to the detected current. Preferably, the differential signal is compared to the upper switching threshold and to the lower switching threshold in a Schmitt trigger, preferably a precision Schmitt trigger, with the hysteresis of the Schmitt trigger being representative of both switching thresholds. The resulting control signal of the Schmitt trigger activates a driver for generating the PWM voltage for supplying the coil.

In one embodiment of the stepper motor control, the sensorless step loss detection is effected by measuring the rise time of the current from the lower switching threshold to the upper switching threshold or the fall time of the current from the upper switching threshold to the lower switching threshold or the period duration composed of rise time and fall time or a multiple thereof, respectively, and comparing it to an upper step loss threshold, with a step loss being detected if said threshold is exceeded.

This embodiment for the detection of step losses is based on the fact that the inductance L_{W} of the stepper motor is dependent on the size of the air gap in the magnetic circuit and hence on the load moment, whereas, in the electrical equivalent circuit diagram of the stepper motor (see FIG. 2), the ohmic resistance R_{W}, the supply voltage U and the current I_{M} can be assumed to be constant and the generator voltage U_{M} is indeed dependent on the rotational speed, but not on the load, and is thus irrelevant for the proposed measurement. According to the invention, the stepper motor is operated in a so-called “current band guide” the hysteresis, i.e., bandwidth, of which is preset. In other words, the stepper motor is activated according to the invention such that the current through the motor coil is kept between a lower and an upper switching threshold, which switching thresholds define the maximum deviations from a reference current path. The reference current path is preferably sinusoidal (in a stepped form). The rise time of the current from the lower to the upper switching threshold as well as the fall time of the current from the upper to the lower switching threshold are proportional to the inductance L_{W}. Thus, the inductance measurement can be transformed into a time measurement which, with regard to circuitry, is feasible very well, e.g., with an FPGA.

For a certain current-dependency of the measurement to be reduced from the result, it is preferred that at least two period durations around the zero point of the current are measured.

If the stepper motor is operated above its start/stop frequency, it happens in case of step losses that the motor will no longer be able to start, but will only vibrate, which manifests itself in a reduced period duration of the current. Therefore, in case of high rotational speeds, it is suitable to measure the rise time or the fall time or the period duration of the current or a multiple thereof, respectively, and to compare it to a lower step loss threshold (tmin), with a step loss being detected if said threshold is fallen short of.

The upper step loss threshold (tmax) and/or the lower step loss threshold (tmin) depend on the motor speed, the motor type and the ratio between the nominal current and the actually supplied current strength. It is therefore envisaged to consider these parameters for the selection of the respective step loss thresholds, wherein the appropriate values are stored in multidimensional lookup tables in a memory or are calculated by a controller, e.g., an FPGA, as functions or as functions which have been piecewise assembled.

In an alternative embodiment of the invention, the step loss detection is effected by sampling the control signal at a predetermined clock frequency and filtering the sampled values. The filtered signal is then stored after each microstep. From two sections each of the filtered signal, a differential signal is calculated and compared to a step loss threshold, with a step loss being detected if said threshold is reached. This embodiment provides the advantage that the inclusion of two-dimensional motor data is not required.

A differential signal formation which makes small demands on the computing power is realized, for example, by calculating the differential signal in each case via a summation of the first half-wave and the second half-wave of the same period of the filtered signal S8.

A significantly smoother differential signal can be obtained if the difference formation means calculate the differential signal on the basis of a subtraction of the full wave of one period from the full-wave of the preceding period of the filtered signal.

In a further alternative embodiment of the invention, the step loss detection is effected by guiding the control signal through a first low-pass filter and, optionally, smoothing it further in a second low-pass filter and, subsequently, supplying the filtered and smoothed signal to arithmetic means in which it is subjected to a curve discussion calculation, in particular a gradient analysis, from which it is detectable whether a step loss has occurred. This embodiment of the invention enables an extensive evaluation of signal forms of the filtered signal, whereby borderline cases of the occurrence of step losses can also most likely be detected correctly.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of embodiments of the present invention can be best understood when read in conjunction with the following drawings, where like structure is indicated with like reference numerals and in which:

FIG. 1 shows the principle of rotor lagging relative to the stator field under a load;

FIG. 2 shows an electrical equivalent circuit diagram of a motor coil;

FIG. 3 shows a block diagram of a stepper motor loss detection circuit according to the invention;

FIG. 4 shows a circuit diagram of a motor coil driver according to the stepper motor activation of the invention;

FIG. 5 shows a time-dependency diagram of the control signals for the motor coil driver as well as of the current band guide according to the invention;

FIG. 6 shows a time-dependency diagram of a section of the pulse-width modulated output current signal of the motor coil driver;

FIG. 7 shows the current path through the motor coil;

FIG. 8 shows the current path through the motor coil in an enlarged illustration, depicted as a signal converted into a voltage signal;

FIG. 9 shows the voltage signal corresponding to the current path through the motor coil and a reference voltage which is sinusoidal in a stepped form, which are applied as an actual value and as a desired value, respectively, for difference formation to the inputs of a differential amplifier of the stepper motor activation according to the invention;

FIG. 10 shows an enlarged illustration of a detail of the signals of FIG. 9;

FIG. 11 shows the output differential signal of the differential amplifier;

FIG. 12 shows the input signal and a reference voltage signal on the precision Schmitt trigger according to the stepper motor activation of the invention;

FIG. 13 shows the control signal of the precision Schmitt trigger, which is a PWM signal;

FIG. 14 shows a diagram of the period duration of a plurality of measured values of the PWM signal as a function of the motor load at a motor speed of 500 steps/sec;

FIG. 15 shows a further diagram of the period duration of a plurality of measured values of the PWM signal as a function of the motor load at a motor speed of 3000 steps/sec;

FIG. 16 shows a diagram of the average period duration of the PWM signal as well as of upper and lower step loss thresholds as a function of the motor speed;

FIG. 17 shows a diagram of the upper step loss threshold of the period duration of the PWM signal depending on the current through the motor coil;

FIG. 18 shows a block diagram of a further embodiment of a stepper motor loss detection circuit according to the invention;

FIG. 19 shows a signal diagram of the essential signals of the embodiment of the invention according to FIG. 18;

FIG. 20 shows a block diagram of a third embodiment of a stepper motor loss detection circuit according to the invention;

FIG. 21 shows a signal diagram which schematically illustrates the gradient analysis according to the embodiment of the invention of FIG. 20; and

FIG. 22 shows an enlarged section of the signal diagram of FIG. 21.

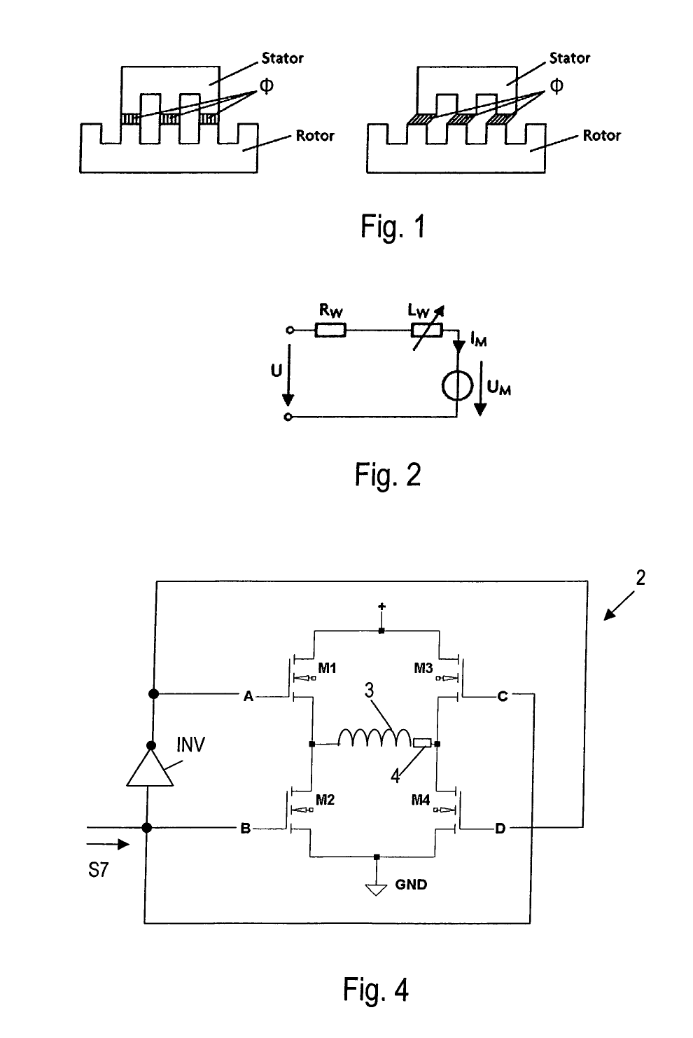

Skilled artisans appreciate that elements in the figures have not necessarily been drawn to scale. For example, the dimensions of some of the elements in the figures may be exaggerated relative to other elements to help improve understanding of the embodiment(s) of the present invention.

### DETAILED DESCRIPTION OF THE INVENTION

In order that the invention may be more readily understood, reference is made to the following examples, which are intended to illustrate the invention, but not limit the scope thereof.

It is noted that terms like “preferably” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

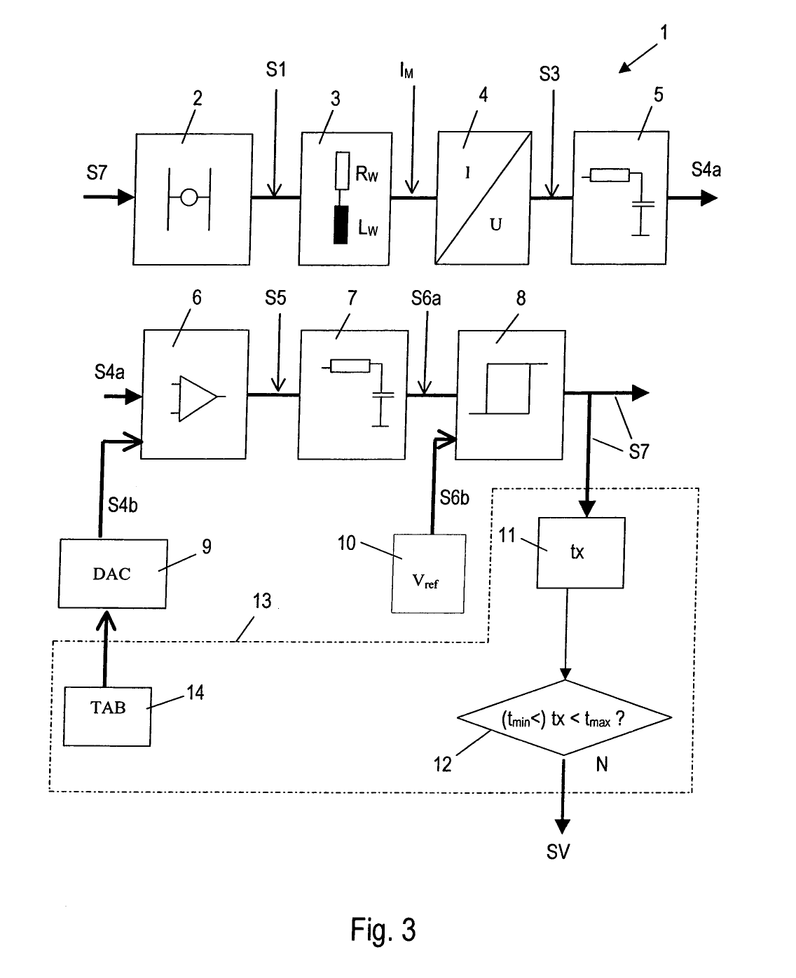

Based on the block diagram of FIG. 3, a detailed description of a motor control 1 according to the invention comprising a step loss detection for a stepper motor, in particular for a hybrid stepper motor, now follows. For the illustration of said exemplary embodiment, it is assumed that the motor control is designed for a two-phase motor, wherein two coils 3 offset relative to each other by 90° are arranged in the stator, with each coil comprising two partial windings located opposite to each other with respect to the rotor. In FIG. 3, a motor coil 3 with its electrical equivalent circuit diagram R_{W} and L_{W} is illustrated. It must be emphasized that the invention is suitable for stepper motors with any number of phases.

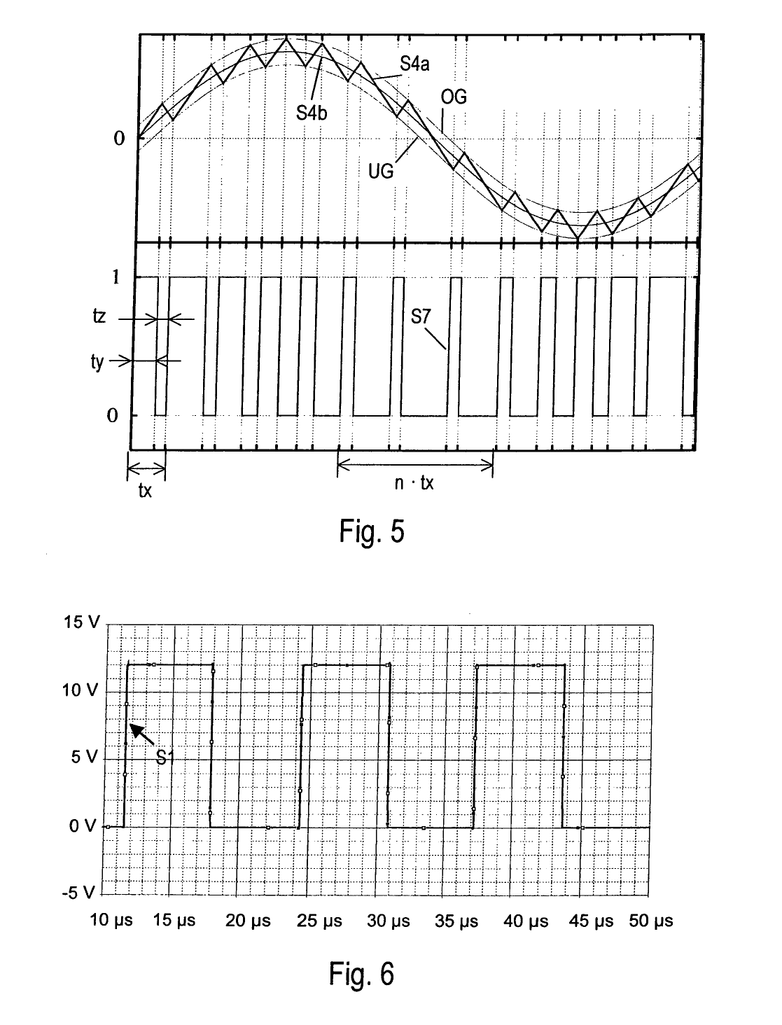

The motor control 1 implements a so-called “current band guide” in which the current I_{M} through the respective motor coil L_{W} is kept within a lower switching threshold UG and an upper switching threshold OG, as is evident from the upper line of the signal/time diagram of FIG. 5. The activation is effected by a pulse width modulated electrical signal S1 (see FIG. 6), the current of the signal S1 is smoothed by the inductance L_{W} of the motor coil 3 so that it exhibits an approximated sinusoidal form, as will be explained in further detail below. Per phase (coil 3) of the stepper motor, one motor control 1 each is required, i.e., two in the present example of a two-phase motor, wherein the drive currents are offset relative to each other by a phase of 90° (generally 180° divided by the number of phases), i.e., in case of a two-phase motor, one motor coil is activated with sinusoidal current and the other one with cosinusoidal current.

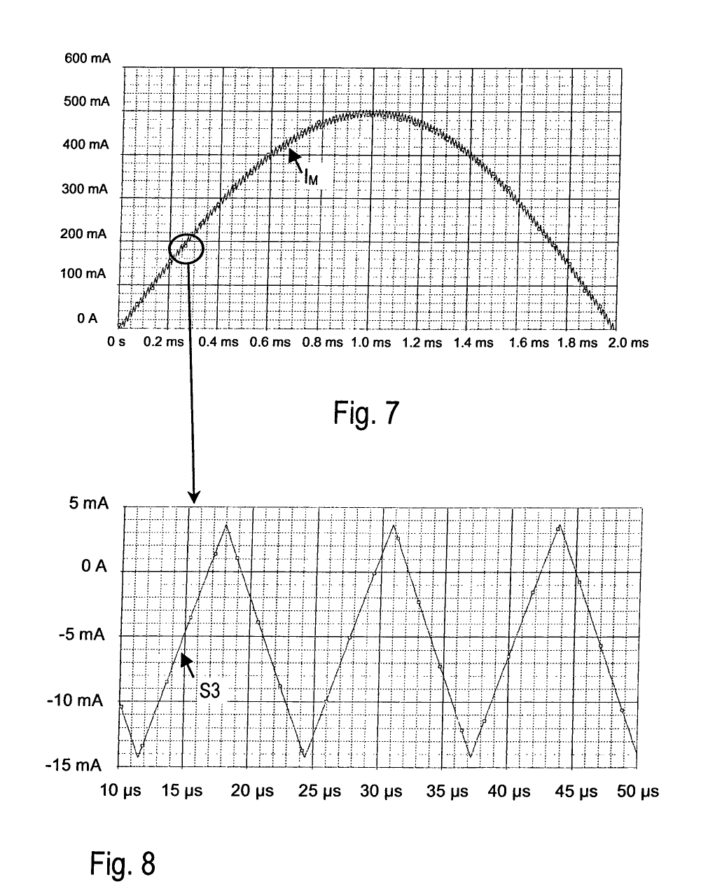

In order to minimize losses, each of the motor coils 3 is activated via one driver 2 each of which comprises an H-bridge (illustrated in the circuit diagram of FIG. 4) by means of a so-called “Locked-Antiphase-PWM” in such a way (see signal S1, illustrated in FIG. 6) that a sinusoidal or cosinusoidal current, respectively, will flow through the two motor coils 3. The driver 2 receives a PWM signal S7, which will be explained in further detail, on its input. Furthermore, the driver 2 comprises an H-bridge consisting of two half bridges which, in each case, are composed of two NMOS transistors M1, M2 and M3, M4, respectively. The coil 3 is connected into the transverse path between the two half bridges. The PWM signal S7 is supplied to the transistors M2, M4 directly as a control signal and to the transistors M1, M3 via an inverter INV in an inverted form. As a result, the transistors always switch on or off diagonally, i.e., either the transistors M1 and M4 are switched on and the transistors M2 and M3 are switched off, or vice versa. The result is that the pulse-width modulated current S1 flows through the coil 3 either in one direction or in the opposite direction, whereby the pulse-width modulated current S1 is smoothed by the inductance L_{W} of the coil 3. The current I_{M} resulting from the smoothing is illustrated in the signal/time diagram of FIG. 7.

The current I_{M} is measured by means of a shunt resistor connected in series with the motor coil and is amplified using a current/voltage transformer 4. FIG. 8 shows the enlarged illustration of a detail of the current signal I_{M} after its transformation into a voltage signal S3 in the current/voltage transformer 4.

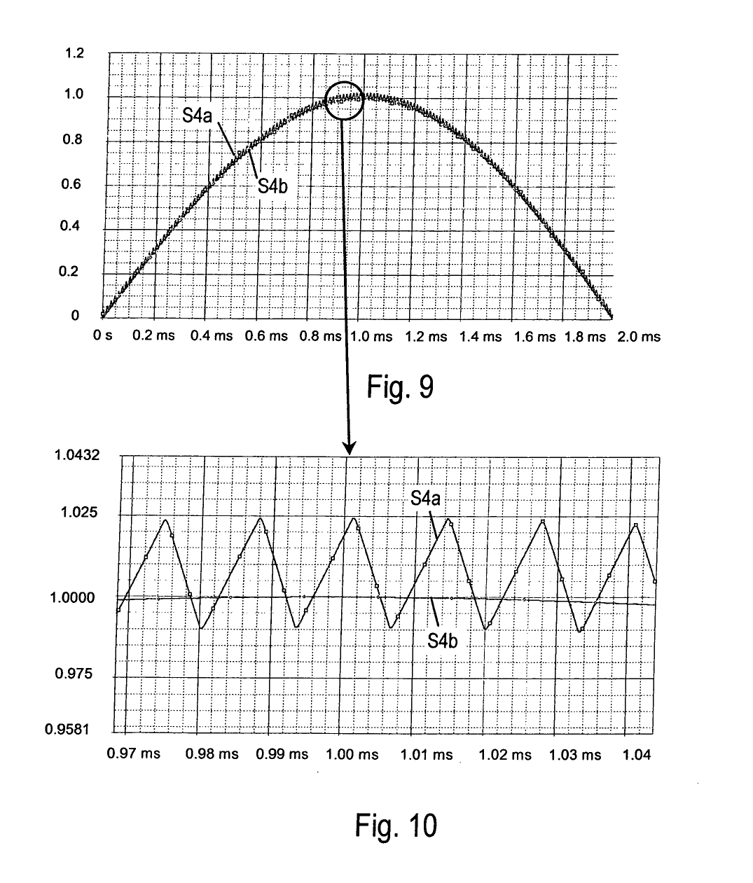

Optionally, an HF filter 5 is arranged downstream of the current/voltage transformer 4 in order to eliminate high-frequency interferences in the voltage signal S3 so that a voltage signal S4a cleared from HF interferences and proportional to the current I_{M} will result. The differential amplifier 6 adjacent thereto is supplied, on the one hand, with the voltage signal S4a and, on the other hand, with a (stepped) sinusoidal default signal (desired value) 4b. The two signals S4a and S4b are depicted in FIG. 9 for half a sine period and, respectively, in FIG. 10 in an enlarged illustration of the crest area of the sinusoidal form. In the differential amplifier 6, the signal S4a (actual value) is subtracted from the signal S4b (desired value) and amplified. The default signal S4b is generated by a D/A converter 9, for example, having a resolution of 12 Bit, wherein the D/A converter 9 has the default values allocated to it on its digital input preferably by an FPGA 13 via a lookup table 14 stored therein.

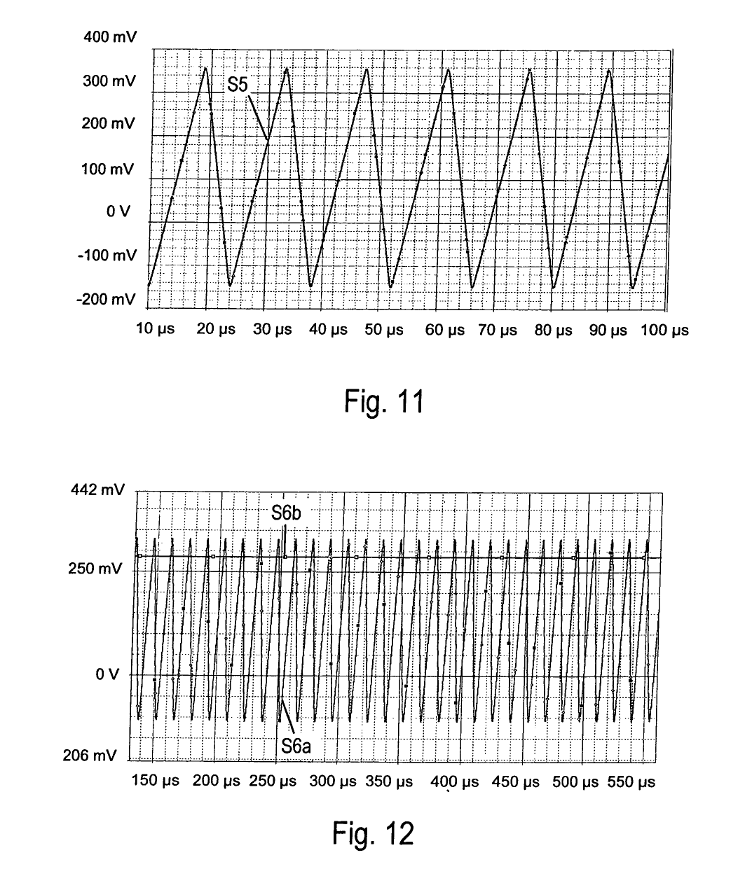

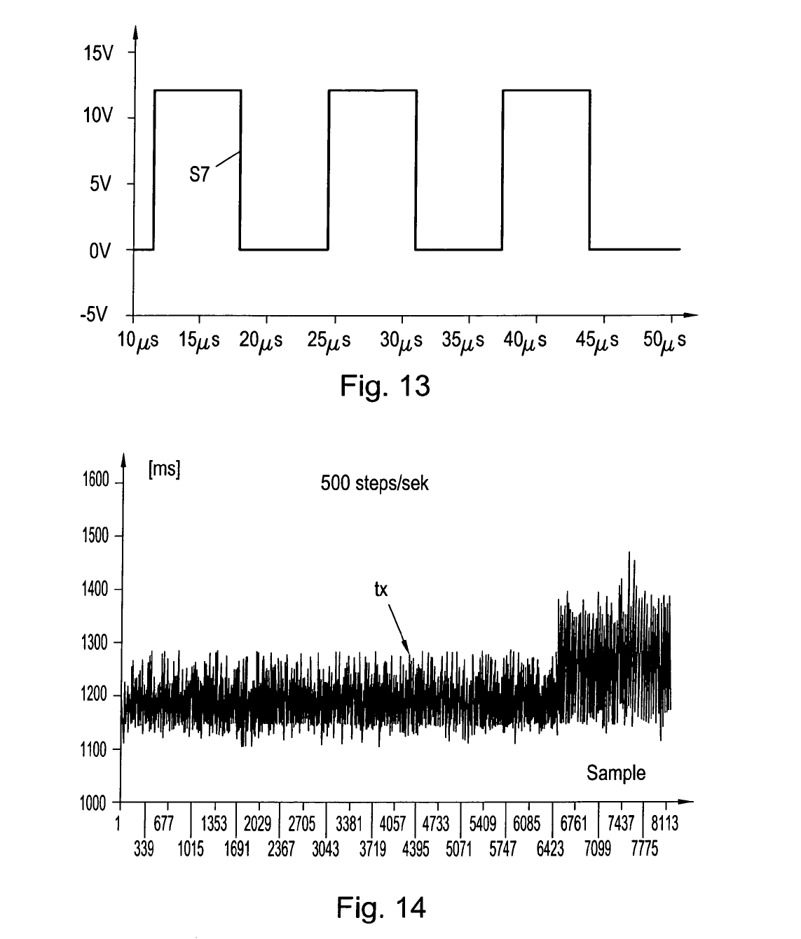

The triangular-shaped output signal S5 (see FIG. 11) of the differential amplifier 6 is optionally filtered once again in an HF filter 7 and is supplied as a filtered signal S6a to an input of a precision Schmitt trigger 8. The precision Schmitt trigger 8 comprises a second input to which a reference voltage signal S6b generated in a reference voltage source 10 is applied, which reference voltage signal determines the upper switching threshold OG of the precision Schmitt trigger 8. The two signals S6a and S6b are illustrated in the diagram of FIG. 12. The lower switching threshold UG is internally determined to be 0 V. The two switching thresholds OG, UG are illustrated in the diagram of FIG. 5, wherein they are a measure of the bandwidth within which the current I_{M} and the voltage signal S4a proportional to the current, respectively, can change relative to the sinusoidal reference voltage S4b. Alternatively, the lower switching threshold UG of the precision Schmitt trigger 8 could be adjusted with a second reference voltage signal. In the precision Schmitt trigger 8, the signal S6a is compared to the two switching thresholds UG, OG (here 0V and 285 mV), and, as a result, a pulse-width modulated (PWM) signal S7 emerges at the output of the precision Schmitt trigger (see FIG. 13), the frequency of which depends on the frequency of the current I_{M} through the motor coil 3 or of the voltage signal S4a derived therefrom, respectively, with the rise and fall of the current I_{M} through the motor coil 3 in turn depending on the inductance L_{W} changing with the load.

The two switching thresholds UG, OG of the precision Schmitt trigger 8 and the adjusted amplification of the differential amplifier 6 determine the level of the current ripple (of the current band) through the motor coil 3, as can be seen best in the time-dependency diagram of FIG. 5.

The control signal S7 of the precision Schmitt trigger 8 is supplied to a timer 11, which can be integrated, e.g., in said FPGA 13, and to the input of the driver stage 2, where it activates the H bridge for the coil 3, as described above.

The timer 11 measures the variable period tx (see FIG. 5) of the control signal S7, which, as explained above, depends on the inductance L_{W} of the motor coil 3 which is variable with the motor load. In a preferred embodiment, n periods around the zero point of the sinusoidal signal S4b (e.g., around about ±30°) are used for the measurement, as is illustrated in FIG. 5. In measurements around the zero point, an existing current-dependency of the measurement reduces itself from the measuring result. As an alternative to the period duration tx, the on-period ty or the off-period tz of the PWM signal S7 can also be measured, which likewise depend on the variable inductance L_{W} of the motor coil 3.

The step loss detection according to the present invention is based on the fact that the period duration tx varies with the motor load and becomes chaotic in case of a step loss. However, the individual measured values of the period duration scatter due to motor vibrations and a varying load moment even without a step loss so that a step loss cannot always be inferred reliably from an absolute value measurement of the period duration tx. Also, the approach of calculating the mean value from the measured values does not always reliably lead to the target, since sometimes the measured period durations indeed scatter extremely in case of a step loss, however, both upwards and downwards, so that the mean value will not always change noticeably. This happens particularly in case of a rigid stop of the rotor.

Therefore, it is preferably suggested that the maximum value of the period duration tx be determined from a plurality of measurements of the period duration tx (or of a multiple thereof) of the signal S7. Namely, it has turned out that, in case of a step loss, very high values occur among the scattering values of the period duration tx. Such a maximum value indeed changes with the load moment, but tends to leap upwards extremely in case of a step loss.

FIG. 14 shows the permanent measured values of period tx recorded at a rotational speed of 500 steps per second for a sample of 8096 measured values. In doing so, the motor (Type.E21H4N-2.5-012) was initially run at idle and stopped after approx. 7000 samples so that it kept losing steps continuously from that moment on. A clear increase in period durations can be observed from the 7000th sample. The difference in period durations between running the motor at idle and stopping it will be the smaller, the more slowly the motor rotates. Below a minimum rotational speed, the detection of step losses will thus be unreliable. Conversely, the difference in period durations between running the motor at idle and stopping it will be the larger, the higher the rotational speed of the motor. This facilitates the determination of an upper step loss threshold tmax of the period duration, the exceedance of which can be detected as a step loss.

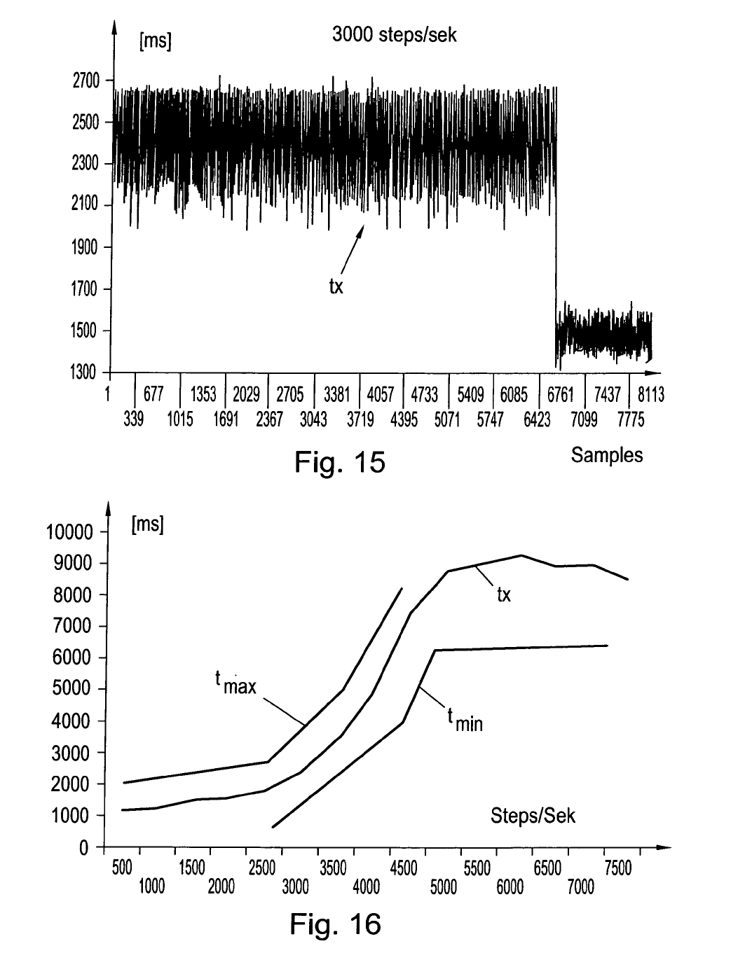

Starting at a motor-dependent maximum speed, the effect reverses, since the motor now exceeds its start/stop frequency. It can no longer start after the first step loss and only vibrates around its rest position. Thereby, however, it no longer absorbs any energy and the current can be introduced into the windings more easily, whereby the current frequency increases and the period duration tx decreases, as can be seen clearly in FIG. 15. Also this effect intensifies with the speed of the motor. The diagram of FIG. 15 was recorded at a motor speed of approx. 3000 steps/sec. Should one wish to operate the stepper motor not only at a speed far below its start/stop frequency, it is thus recommendable for a reliable step loss detection to compare the measured period duration tx also to a lower step loss threshold tmin and to detect a step loss, if said lower step loss threshold tmin is fallen short of.

FIG. 16 shows a diagram of the dependency of the period duration tx on the rotational speed of the stepper motor, wherein the period duration tx has, in each case, been calculated as a mean value from 5000 measured values at intervals of 500 steps/sec and has been plotted into the diagram.

In practice, the tested stepper motor is suitably operated in a frequency range from 600 to approx. 2500 steps/sec. In said range, the curve is relatively linear, whereby the upper step loss threshold tmax does not have to be determined as a lookup table for each individual speed, but can also be approximated via a straight line or a higher-order function, as is illustrated in FIG. 16. The upper step loss threshold tmax can be assembled from individual straight line sections for values of above 2500 steps/sec.

From the diagram of FIG. 16, it is also evident that the period duration tx increases disproportionately from about 4000 steps/sec and remains reasonably constant from about 5500 steps/sec. However, with those high rotational speeds, minor motor loads are already sufficient for bringing the stepper motor out of step and, respectively, the motor approaches its mechanical limit. Since the motor is operated above its start/stop frequency at those speeds, single step losses are sufficient for the motor to fall completely out of step. This means that the lower step loss threshold tmin is decisive for the step loss detection in this speed range. It should thereby be noted that the terms “lower step loss threshold tmin” and “upper step loss threshold tmax” do not denote absolute values, but, just like the period duration tx, change with the motor speed. In addition, the motor should not be operated at higher speeds on a continuous basis, either, since the load on the bearings is extremely large and hence the lifetime of the motor decreases drastically. As stated above, a speed range from 600 to approx. 2500 steps/sec is recommendable for the tested motor. For other motors, speed ranges deviating therefrom can be indicated.

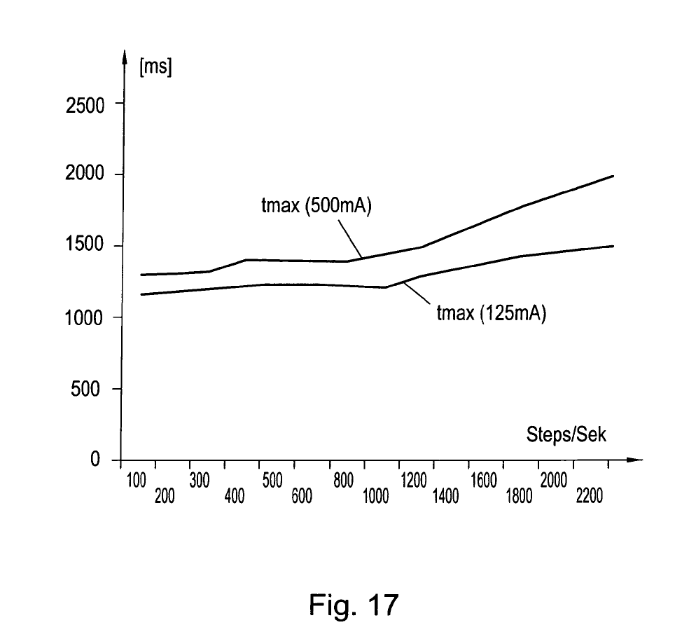

In previous explanations, it has been assumed that the motor is operated with nominal current. However, the measured period durations tx also depend on the winding current. Therefore, in a further experiment for the same motor, empirically functioning upper step loss thresholds tmax have been determined as before for the step loss detection with nominal current (500 mA/winding) and with 25% of the nominal current (125 mA/winding). The results are illustrated in FIG. 17. It can be seen from the diagram of FIG. 17 that the step loss thresholds remain approximately the same across a relatively wide frequency range and then increase linearly from a cutoff frequency. However, the curve shifts toward small values with a decreasing current, and the cutoff frequency changes as well. In practice, this means that a lookup table for the step loss thresholds tmax, tmin has to be created in the FPGA 13 or the like or the respective step loss threshold has to be calculated internally according to a function or according to functions which have been piecewise assembled. If a current control is to be implemented, i.e., the motor is operated not only with nominal current, the lookup table becomes two-dimensional. In practice, the number of different speeds at which a stepper motor is operated is limited, which in turn reduces the size of the lookup table.

By means of the invention, several motors can also be activated simultaneously by one FPGA in a resource-saving manner, with the execution occurring sequentially in the FPGA, e.g., using an implemented state machine which assumes this task. As a result, the motor activation and also the step loss detection do not have to be instanced multiple times.

The switching thresholds of the Schmitt trigger 8 are adaptable to different motors.

In order to implement a motor activation 1 which is to be suitable for different motor types, step loss threshold functions or step loss lookup tables have to be created for all motor types which are provided. Suitably, this process is carried out in an automated fashion on a test stand which automatically receives the motor diagrams and stores them in a memory or in the FPGA 13, respectively.

In simple applications for which it suffices to determine step losses with a precision of one motor revolution, the period duration measurement as proposed needs to be realized only on one coil 3 or on the activation circuit 1 thereof, respectively, wherein the activation circuit 1 will then also perform the activation of the drivers of the other coils of the motor with a fixed phase displacement. However, for more precise applications, it is recommendable to provide one activation circuit 1 with the period duration measurement according to the invention for each motor coil so that the precision of the step loss detection will amount to one step length between two adjacent motor coils.

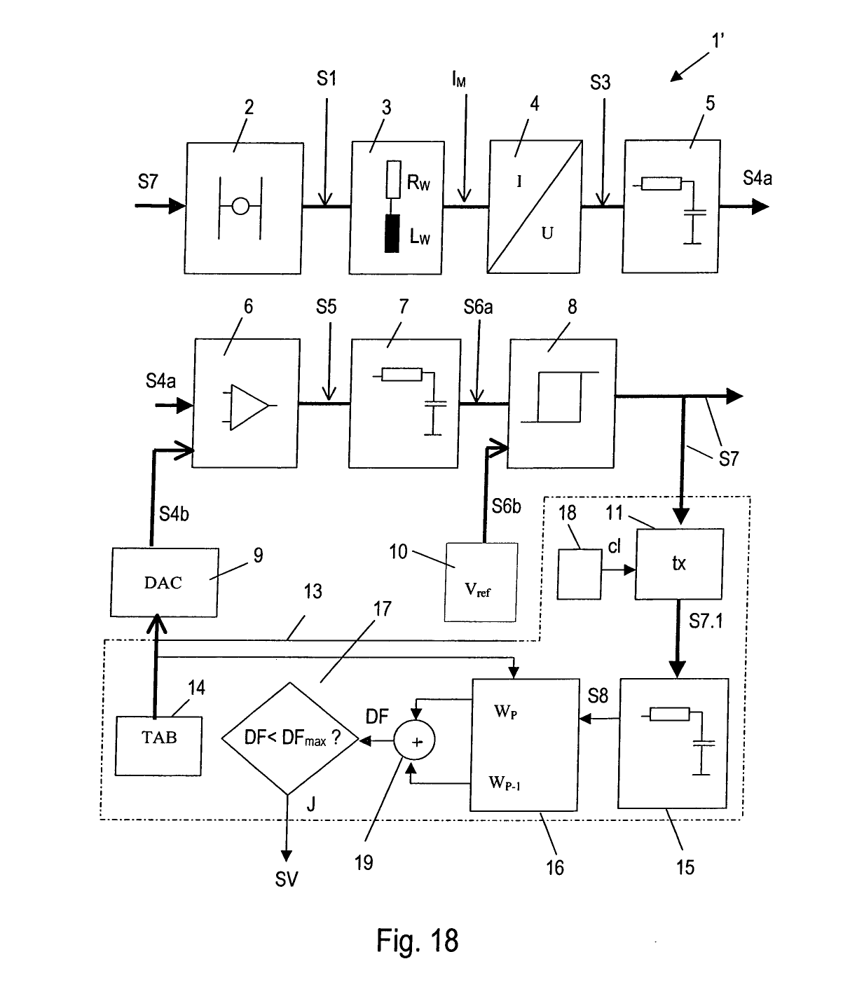

An explanation of a second embodiment of a motor control 1′ according to the invention comprising a step loss detection for a stepper motor now follows on the basis of the block diagram of FIG. 18. Components of said motor control 1′ which are equal to those in the first embodiment of the motor control 1 are provided with the same reference characters. For an explanation of their functions, the above description of the first embodiment of the motor control 1 is pointed out. The second embodiment of the motor control 1′ comprising a step loss detection differs from the first one essentially by a different evaluation of the control signal S7 for the step loss detection. More precisely, the control signal S7 is sampled at a predetermined clock frequency, and the sampled values S7.1 are supplied to a low-pass filter 15. Said low-pass filter 15 is preferably a higher-order filter and can be configured, for example, as an analog low-pass filter or as a digital filter designed with the properties of an analog low-pass filter. For a resource-saving consumption of switching circuits in the FPGA 13, e.g., three digital filters with the properties of analog first-order low-pass filters are designed in a mathematically simplified manner and are series-connected. In doing so, the filter coefficient for each filter is chosen such that, on the one hand, the switching frequency S7 which is generated due to the default signal S4b (typically approx. 70 KHz) is suppressed properly (>60 dB) and, on the other hand, the differential signal DF illustrated below is attenuated as little as possible in the event of the occurrence of step losses. The filtered signal S8 has essentially the same period as the current I_{M}. The filtered signal S8 is sampled at a predetermined clock frequency cl generated by a clock generator 18 in the FPGA 13, and the sampled values of the filtered signal S8 are stored in a memory 16. The clock frequency corresponds with those instants at which the FPGA 13 prescribes a new microstep and a full PWM cycle is finished.

It should be mentioned that the filtered signal S8 is provided at the output of the low-pass filter 15 either already in a digital form so that “sampling” consists only in inputting the digital values into the memory 16 at clock rate cl, or in an analog form, which requires the interposition of an analog-to-digital converter between the filter output and the memory. Difference formation means 19 calculate a differential signal DF from, in each case, two sections of at least one period of the filtered signal S8, which period is stored in the memory 16. Comparison means 17 compare the differential signal DF to a step loss threshold DFₘₐₓ (prestored, e.g., in the FPGA 13) and generate an output signal representing the step loss SV when the step loss threshold DFₘₐₓ is reached or exceeded.

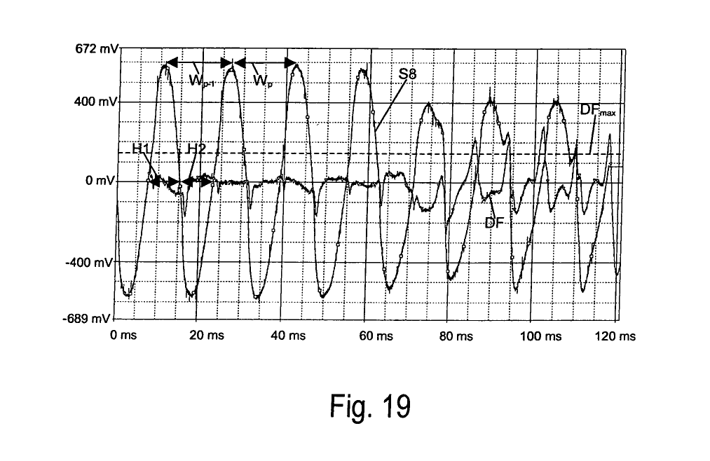

FIG. 19 shows the temporal form of the filtered signal S8 and of the differential signal DF in a time-dependency diagram. Therein, the differential signal DF has been calculated, in each case, via a summation of the first half-wave H1 and a second half-wave H2 of the same period (e.g., period Wₚ or period Wₚ₋₁) of the filtered signal S8. This calculation method requires a small hardware expenditure of the difference formation means 19, in practice, however, distinct spikes are noticeable in the differential signal DF. A substantially smoother differential signal DF can be obtained if the difference formation means 19 calculate the differential signal DF from a subtraction of the full-wave of a (i.e., the current) period Wₚ from the full-wave of the preceding period Wₚ₋₁ of the filtered signal S8. Interferences due to unsymmetric half-waves are thereby eliminated. As is evident, a step loss occurs at 70 ms. After a short delay, the differential signal DF exceeds the step loss threshold DFₘₐₓ.

In general, the second motor control 1′ provides the advantage over the first motor control 1 that the inclusion of two-dimensional motor data is not required. Furthermore, a better distinction between the normal operation and a step loss is possible, since the signal level differs by a factor >10 in case of a step loss.

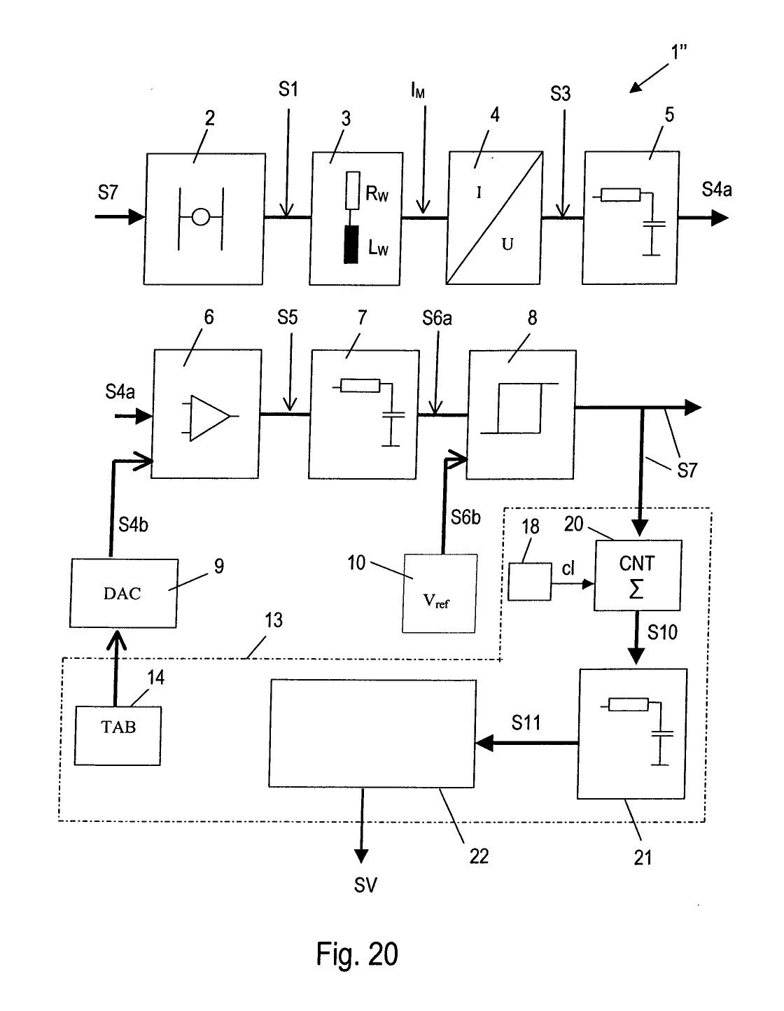

An explanation of a third embodiment of a motor control 1″ according to the invention comprising a step loss detection for a stepper motor now follows on the basis of the block diagram of FIG. 20. Components of said third motor control 1″ which are equal to those in the two embodiments illustrated above are provided with the same reference characters. For an explanation of their functions, the above description is pointed out.

The third embodiment of the motor control 1″ comprising a step loss detection exhibits an evaluation of the control signal S7 for the step loss detection which is different compared to the first two embodiments by guiding the control signal S7 through a first low-pass filter 20, smoothing the prefiltered signal S10, which has essentially the same period as the current I_{M}, further in a second low-pass filter 21 and subsequently supplying the filtered and smoothed signal S11 to arithmetic means 22 in which it is subjected to a curve discussion calculation, in particular a gradient analysis, from which it is detectable whether a step loss SV has occurred.

The first low-pass filter 20 is designed as a digital integrator comprising a counter CNT which, if the control signal S7 is on a high level, counts upwards at a predetermined clock frequency cl generated by a clock generator 18 and, if the control signal S7 is on a low level, counts downwards at a predetermined clock frequency. It is of course understood that the integrator can be varied such that the counter counts upwards at a low level and downwards at a high level.

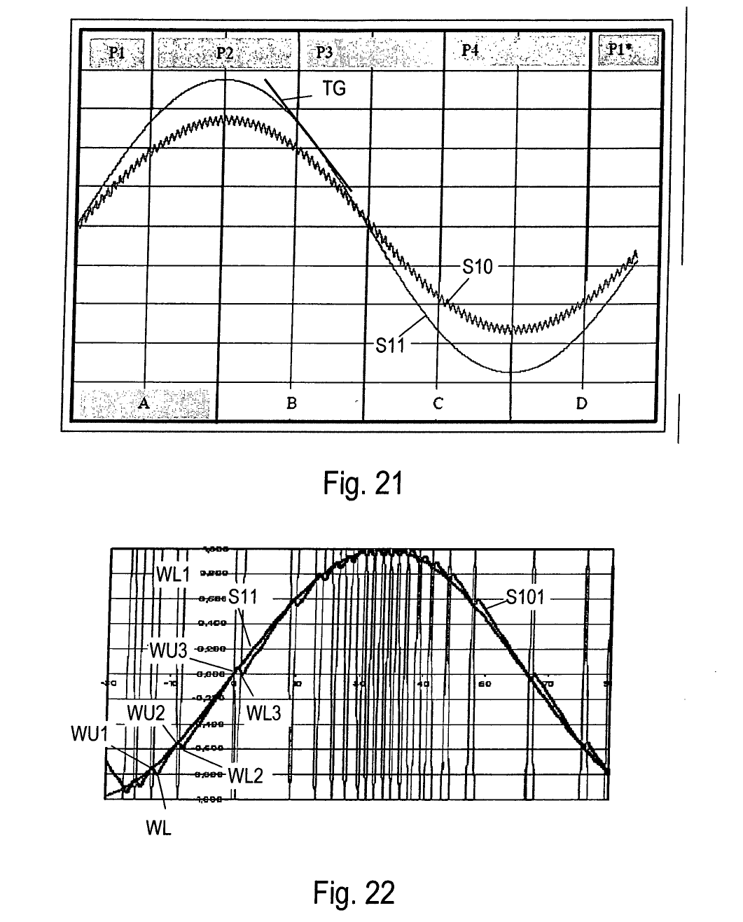

By a permanent summing-up (integration) of the PWM control signal S7, the motor current is roughly reproduced without taking the losses into account. With this method, spikes as a result of artefacts of the circuit are ignored and the desired global consideration of the curve is made possible. In practice, the obtained curves (see signal diagrams of FIGS. 21 and 22) turn out to be largely homogeneous sine waves (apart from saturation effects) superimposed by an ascending straight line. Said line corresponds to the losses in the physical arrangement (electronics+motor) which really are settled by the PWM and are not present in the purely mathematical sum (=integral of the ideal sine). The global discussion of the filtered signal S11 permits various similarity considerations such as, e.g., the qualitative comparison of curves of motor phases corresponding to each other. Among other things, a correction or resetting, respectively, of the integral as a result of the permanent losses is required here so that the technical implementation becomes possible in the form of the mathematical calculation (no drifting).

The second low-pass filter 21 arranged downstream of the first low-pass filter 20 is designed as a discrete filter the discrete filtering points of which are inflection points WL1, WL2, WL3 and WU1, WU2, WU3, respectively, of the filtered signal S10, see signal diagram of FIG. 22, from which it is also evident that the signal S11 filtered in the second low-pass filter 21 exhibits a significantly smoother signal form.

For the discrete filter 21, a filtering function can be determined by using only the upper inflection points WU1, WU2, WU3 of the prefiltered signal S10 as discrete filtering points. A further filtering function is determined by using only the lower inflection points WL1, WL2, WL3 of the filtered signal S10. The upper and the lower filtering functions form a band which is a measure of the amplitude of the control. If said control band is narrow, the location is in the range of the maximum or minimum of the sinusoidal curve. This information is used if the tangent TG (see FIG. 21) is determined, i.e., a gradient analysis is performed, since the gradient analysis does not always function reliably in the range of the maximum and minimum, therefore, these ranges are hidden in the gradient analysis. The determination of the curve slopes (TG) can be done continuously or in sections, wherein, for a determination in sections, an averaged section curve slope is suitably calculated. For reducing the computing time, a fall/rise decision can simply be made instead of an averaged section curve slope, wherein several sections P1, P2, P3, P4 and A, B, C, D, respectively, are pooled in groups which, in each case, are evaluated with regard to the detection of step losses. The groups may also overlap, as can be seen in FIG. 21, where each section of each group comprises a 90° angle, but the sections of the different groups are offset relative to each other by 45°.

The calculation of the gradient of the filtered signal S11 for the determination of step losses is based on the consideration that the form of the gradient has to be monotonic at least over partial sections and that the occurrence of unexpected gradient conditions or changes during particular motor phases indicates a step loss. Thus, it is possible, for example, to consider the correct sequence of gradient alternations in the sine and cosine branch of the motor activation and to determine the current direction of rotation of the motor. By observing the determined zero crossings, the steps of the stepper motor can be taken into account.

Expanding the above consideration, the arithmetic means 22 are designed for determining the derivations of the curve slopes (TG), i.e., the curve bends. This measure is based on the consideration that, during particular motor phases, monotony is assumed for the gradient itself: The signum of the bend must be constant within the determined inflection points.

The clarification of the principle of monotony of the periods occurs on the basis of the filtered signal S11 according to the illustration of FIG. 22. The period duration intensifies once between two zero crossings, i.e., only one extreme value of the signal S11 exists. There, the period duration is minimal and the amplitude is maximal. The result is as follows: In the entire range, the second derivation of the curve must be permanently negative. Accordingly, the second derivation which has been determined must be positive during the negative half-wave. This is the case here, from which the conclusion can be drawn that the event of a step loss is not existent.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1.-30. (canceled)

31. A process for detecting step losses of a stepper motor, comprising:
supplying a pulse-width modulated voltage to a coil of the stepper motor,
detecting current flowing through the coil,
determining whether the detected current lies within a current bandwidth defined by an upper switching threshold and a lower switching threshold, the current bandwidth being based on a default value,
applying current to the coil when the detected current has dropped to the lower switching threshold,
removing current from the coil when the detected current has risen to the upper switching threshold, and
detecting a step loss based on a signal form of the detected current.

32. The process of claim 31, wherein detecting the step loss includes detecting the step loss based on whether a control signal corresponding to the detected current is within a desired range of values.

33. The process of claim 31, further comprising:
allocating values from a controller to a digital input of a digital-to-analog converter, the controller being a field-programmable gate array, and
generating the default value in the digital-to-analog converter based on the allocated values.

34. The process of claim 31, further comprising:
subtracting the detected current from the default value to create a proportionate voltage signal, the default value being a generally sinusoidal default value, and
amplifying the proportionate voltage signal,
wherein determining whether the detected current lies within the current bandwidth includes comparing the amplified proportionate voltage signal with the upper switching threshold and the lower switching threshold.

35. The process of claim 34, wherein comparing the amplified proportionate voltage signal with the upper switching threshold and the lower switching threshold includes using a precision Schmitt trigger to compare the amplified proportionate voltage signal with the upper switching threshold and the lower switching threshold and generating a control signal at an output of the Schmitt trigger based on the comparison of the amplified proportionate voltage signal with the upper switching threshold and the lower switching threshold.

36. The process of claim 35, further comprising:
sampling the control signal at a predetermined clock frequency to generate a plurality of sample values,
filtering the plurality of sample values through a low-pass filter to generate a filtered signal having a plurality of sections,
storing the filtered signal in a memory upon each microstep change and completed period duration of the filtered signal, and
calculating a differential signal from at least two sections of the filtered signal,
wherein the step loss is detected when the differential signal exceeds a step loss threshold.

37. The process of claim 36, wherein the differential signal is calculated from a first half-wave section and a second half-wave section of the same period of the filtered signal, the first half-wave section and the second half-wave section beginning at a zero crossing of the generally sinusoidal default value.

38. The process of claim 36, wherein the differential signal is calculated from a first full-wave section of a first period of the filtered signal and a second full-wave section of a second period of the filtered signal preceding the first period.

39. The process of claim 35, further comprising:
filtering the control signal by integration through a low-pass filter to generate a filtered signal, and
subjecting the filtered signal to a curve discussion calculation, the curve discussion calculation including gradient analysis,
wherein the step loss is detected when a result of the curve discussion calculation lies outside of fixed limits.

40. The process of claim 39, wherein filtering the control signal by integration through the low-pass filter includes:
counting upwards at a first predetermined clock frequency when the control signal is on a high level, and
counting downwards at a second predetermined clock frequency when the control signal is on a low level.

41. The process of claim 39, wherein subjecting the filtered signal to the curve discussion calculation comprises determining curve slopes.

42. The process of claim 41, wherein determining curve slopes includes pooling several sections of the curve slopes into a plurality of groups and evaluating each of the plurality of groups to detect step losses.

43. The process of claim 35, further comprising activating a driver to supply the pulse-width modulated voltage to the coil of the stepper motor using the control signal of the Schmitt trigger.

44. The process of claim 31, wherein:
the signal form of the detected current includes one of a rise time of the detected current from the lower switching threshold to the upper switching threshold, a fall time of the detected current from the upper switching threshold to the lower switching threshold, and a period duration composed of the rise time and the fall time, and
the step loss is detected when the signal form of the detected current is greater than an upper step loss threshold, the upper step loss threshold being based on one of a stepper motor speed, a stepper motor type, and a stepper motor current.

45. The process of claim 31, wherein the signal form of the detected current includes one of a rise time of the detected current from the lower switching threshold to the upper switching threshold, a fall time of the detected current from the upper switching threshold to the lower switching threshold, and a period duration composed of the rise time and the fall time, and
the step loss is detected when the signal form of the detected current is less than a lower step loss threshold, the lower step loss threshold being based on one of a stepper motor speed, a stepper motor type, and a stepper motor current.

46. The process of claim 45, wherein the lower step loss threshold is stored in a plurality of lookup tables in a memory.

47. A device for detecting step losses of a stepper motor, comprising:
a current driver to supply a pulse width modulated current to a coil of the stepper motor,
a current/voltage transformer electrically coupled to the current driver to detect current flowing through the coil and generate a voltage signal proportional to the detected current,
a comparator to determine whether the detected current lies within a current bandwidth defined by an upper switching threshold and a lower switching threshold, the current bandwidth being based on a default value, the comparator being configured to generate a control signal to control the current driver such that a current supply to the coil is switched on when the detected current has dropped to the lower switching threshold and the current supply to the coil is switched off when the detected current has risen to the upper switching threshold, and
an analyzer to analyze a signal form of the detected current and detect a step loss based on the signal form of the detected current.

48. The device of claim 47, wherein the signal form of the detected current is the control signal.

49. The device of claim 47, further comprising:
a digital-to-analog converter electrically coupled the comparator, and
a controller electrically coupled to a digital input of the digital-to-analog converter, the controller being a field-programmable gate array,
wherein the controller is configured to allocate values to the digital input of the digital-to-analog converter and the digital-to-analog converter is configured to generate the default value based on the allocated values, the default value being a generally sinusoidal default value.

50. The device of claim 49, wherein the comparator comprises a differential amplifier, the differential amplifier including:
a first input electrically coupled to the digital-to-analog converter to receive the generally sinusoidal default value, and
a second input electrically coupled to the current/voltage transformer to receive the voltage signal proportional to the detected current.

51. The device of claim 50, wherein the comparator further comprises:
a Schmitt trigger electrically coupled to (i) the differential amplifier to receive an output signal of the differential amplifier, and (ii) the current driver,
the Schmitt trigger having a hysteresis defining the upper switching threshold and the lower switching threshold, and
the Schmitt trigger is configured to generate the control signal to activate the current driver to supply the pulse-width modulated current to the coil.

52. The device of claim 51, wherein the controller is configured to sample the control signal generated by the Schmitt trigger at a predetermined clock frequency, and the controller includes:
(i) a low-pass filter to filter the sampled values of the control signal and generate a filtered signal having essentially the same period as the detected current,
(ii) a difference formation means for calculating a differential signal from two sections of at least one period of the filtered signal, and
(iii) a second comparator to compare the differential signal to a step loss threshold such that the step loss is detected when the step loss threshold is reached.

53. The device of claim 52, wherein the two sections of the at least one period of the filtered signal include a first half-wave section and a second half wave section of the same period, with the first half-wave section and the second half-wave section beginning at a zero crossing of the generally sinusoidal default value.

54. The device of claim 52, wherein the two sections of the at least one period of the filtered signal include a first full-wave section of a first period and a second full-wave of a second period preceding the first period.

55. The device of claim 51, wherein the controller includes:
(i) a low-pass filter to filter the control signal generated by the Schmitt trigger and generate a filtered signal, and
(ii) a processor to receive the filtered signal, the processor being configured to perform a curve discussion calculation including a gradient analysis and to detect whether results of the curve discussion calculation lie outside of fixed limits.

56. The device of claim 55, wherein the low-pass filter is an integrator comprising a counter configured to (i) count upwards at a first predetermined clock frequency when the control signal is on a high level, and (ii) count downwards at a second predetermined clock frequency when the control signal is on a low level.

57. The device of claim 56, wherein the processor is configured to determine curve slopes.

58. The device of claim 47, further comprising:
a timer electrically coupled to the comparator, the timer being configured to measure a time period including one of a rise time of the detected current from the lower switching threshold to the upper switching threshold, a fall time of the detected current from the upper switching threshold to the lower switching threshold, and a period duration composed of the rise time and the fall time of the detected current, and
a second comparator to compare the measured time period to an upper step loss threshold such that the step loss is detected when the measured time period is greater than the upper step loss threshold.

59. The device of claim 47, further comprising:
a timer electrically coupled to the comparator, the timer being configured to measure a time period including one of a rise time of the detected current from the lower switching threshold to the upper switching threshold, a fall time of the detected current from the upper switching threshold to the lower switching threshold, and a period duration composed of the rise time and the fall time of the detected current, and
a second comparator to compare the measured time period to a lower step loss threshold such that the step loss is detected when the measured time period is less than the lower step loss threshold.

60. The device of claim 59, further comprising a memory electrically coupled to the second comparator, the memory having stored therein the lower step loss threshold in a plurality of lookup tables.
